(19) United States
(12) Patent Application Publication
(10) Pub. No.: US 2013/0179097 A1
(43) Pub. Date: Jul. 11, 2013

(54) METHOD FOR MONITORING A MEASURING CHAIN OF A TURBOJET ENGINE

(71) Applicant: SNECMA, Paris (FR)

(72) Inventors: Jean-Remi Andre MASSE, Moissy-Cramayel Cedex (FR); Xavier Boulet, Moissy-Cramayel Cedex (FR)

(73) Assignee: SNECMA, Paris (FR)

(21) Appl. No.: 13/692,730

(22) Filed: Dec. 3, 2012

(30) Foreign Application Priority Data
Dec. 5, 2011 (FR) 11 61170

(51) Int. Cl. G01M 15/14

(52) U.S. Cl. CPC G01M 15/14
USPC 702/55

(57) ABSTRACT

A method for monitoring a measuring chain of an aircraft turbojet engine, the measuring chain including at least two replicated channels for measuring a variable of the turbojet engine, the method including a step for measuring the position of a fuel metering valve of the turbojet engine during the flight of the aircraft and a step for normalizing the deterioration indicator according to the position of the fuel metering valve.

The present invention relates to the monitoring field of a measuring chain of a turbojet engine and, more particularly, to a method for predicting a failure of the measuring chain.

Generally, a measuring chain of a turbojet engine comprises two replicated channels intended to collect physical measurements relative to the turbojet engine of an aircraft over the time. These measurements can relate to temperature, pressure, RPM (revolutions per minute), LVDT (Linear Variable Differential Transformer), etc. In practice, each measuring channel includes a probe connected, through connectors and harness, to a computer controlling the turbojet engine.

In order to make sure that the measurements achieved by the measuring chain are correct, it is known how to monitor the measurements of the measuring chain. A simple monitoring consists in testing the integrity of the measuring chain by detecting possible short or open circuits. Besides, it is known how to achieve so-called “area” tests during which it is verified whether a measurement is coherent by comparing this measurement with the precision of the sensor and/or the physical limit of the sensor of the measuring chain.

Classically, it is known how to achieve an a posteriori monitoring of the measurements made by a replicated measuring chain at the time of appearance of a failure. The monitoring of the measuring chain makes it possible to identify the nature of the failure during the maintenance operation. In practice such an a posteriori monitoring method makes it possible to identify the channel of the measuring chain to be repaired or replaced.

When a failure arises in the measuring chain, it is necessary to make a maintenance operation on the turbojet engine, which can entail a grounding of the aircraft on which the turbojet engine is mounted. To increase the availability of an aircraft, one of the objectives is to monitor a measuring chain in order to predict the next failure before it arises.

To predict a failure, the deterioration of a measuring chain is monitored over the time. In a known manner, deterioration indicators are formed by measuring the deviations, on the one hand, between the replicated measuring channels and, on the other hand, between a definite measuring channel and an internal theoretical model simulating a thermodynamic value of the turbojet engine (pressure, temperature, etc.). To obtain a deterioration indicator, for example statistical tests are applied to the deviations, for example Wald statistical tests in order to detect an average jump and a variance jump, and Student statistical tests in order to detect drift jumps. Thanks to these statistical tests, it is advantageously possible to form deterioration indicators for skew, drift, noise or intermittent contact. The forming of such standardized indicators is known, for example, from application FR 2 939 924.

After having obtained the deterioration indicators for a given turbojet engine, a comparison of the said deterioration indicators with reference indicators is achieved so as to infer from it the most likely type of deterioration. A deterioration decision is then taken on the basis of the calculation of an abnormality score as set out in application FR 2 939 924. According to the evolution of this abnormality score for all the deterioration indicators, it is possible to infer from it the element of the measuring chain which is going to break down soon. A step for maintaining the measuring chain can thus be anticipated so as to limit the downtime of the aircraft on which the turbojet engine is mounted.

In practice, the internal theoretical model simulating a thermodynamic value of the turbojet engine, which is used to form a deterioration indicator, is a model that is defined for an average turbojet engine. As a result, the deterioration indicators are not precisely defined and detection of a failure of the measuring chain is less early.

The objective of the present invention aims at increasing the precision of the prediction by improving the accuracy of the deterioration indicators while making it possible to obtain the deterioration indicators easily.

In order to eliminate at least some of these drawbacks, the invention relates to a method for monitoring a measuring chain of an aircraft turbojet engine, the measuring chain comprising at least two replicated channels for measuring a variable of the turbojet engine, the method including:
a step for measuring a variable of the turbojet engine by each of the two measuring channels during a flight of the aircraft;
a step for estimating the said variable by means of a mean theoretical internal model of the turbojet engine;
a step for calculating a deviation between the measurement of one of the measuring channels and the estimate of the said variable in order to form an indicator of deterioration of the measuring chain;
a step for comparing the deterioration indicator with a reference base of indicators with deterioration so as to infer from it the type of deterioration;
a step for calculating an abnormality score for the deterioration indicator;
a step for comparing the abnormality score with a decision threshold of abnormality characteristic of the type of deterioration;
a step for releasing an alarm in case of violation of the decision threshold of abnormality;

method including a step for measuring the position of a fuel metering valve of the turbojet engine during the flight of the aircraft and a step for normalizing the deterioration indicator according to the position of the fuel metering valve.

The invention removes the estimation imprecision of the theoretical model of the turbojet engine. For the indicator is normalized according to the operating mode of the turbojet engine, which makes it possible to correct the inaccuracies that are correlated with the operating mode of the turbojet engine. By improving the accuracy of the deterioration indicators, any failure of the measuring chain is detected precisely and early. Besides, the normalization of the deterioration indicator is easy given that it requires the knowledge of only one operating variable of the turbojet engine. Finally, the choice of the position of the fuel metering valve is advantageous given that this position is characteristic of the operation of the turbojet engine and considering that this position can be easily measured in a turbojet engine.

Preferentially, the deterioration indicator is normalized only according to the position of the fuel metering valve as an operating characteristic of the turbojet engine. A given deterioration indicator can thus be normalized with other deterioration indicators, besides the position of the fuel metering valve. According to another aspect of the invention, the deterioration indicator is normalized according to several operating variables of the turbojet engine.

Preferably, the deterioration indicator is normalized using a normalization model obtained by learning from data of flight without deterioration, the normalization model depending on the position of the fuel metering valve. A deterioration indicator can thus be accurately characterized by learning the normalization model during a plurality of no-deterioration flights and taking account of the position of the fuel metering valve. Still preferably, the normalization model is obtained by regression of the deterioration indicator representing the deviation between the measuring channel and the mean theoretical model according to the position of the fuel metering valve.

Preferentially, the turbojet engine comprising a low-pressure body and a high-pressure body, the measured variable of the turbojet engine is the pressure at the output of the high-pressure compressor.

Preferably, the method includes a step for calculating a mean deviation or a root mean square deviation (RMS deviation) between the measurement of one of the measuring channels and the estimate of the said variable by the mean theoretical model in order to form an indicator of deterioration of the measuring chain. Advantageously, the mean deviation between channel and model is sensitive to skew or drift-type deteriorations. The RMS deviation between channel and model is sensitive to noise-type deteriorations.

According to an aspect of the invention, the method includes a step for calculating a mean deviation or a RMS deviation between at least one of the two measuring channels of the said chain for measuring the said given variable and at least one of the two measuring channels of a chain for measuring the ambient pressure of the turbojet engine. Preferably, the deviation is calculated on the ground, before the turbojet engine starts up. Still preferably, the rotors of the turbojet engine are not in rotation. When measuring the deviations between measurements achieved by two measuring chains, here pressures P23 and P0, an increase in the number of deterioration indicators and an improvement in the detection of a failure of a measuring chain channel are obtained. For pressures P23 and P0 are in principle equal before the turbojet engine starts up. Any deviation is thus a sign of deterioration.

According to another aspect of the invention, the method includes a step for calculating a deviation between at least one of the two measuring channels of the said chain for measuring the said given variable and the measurement of the ambient pressure of the turbojet engine supplied by the aircraft on which the turbojet engine is mounted. Preferably, the deviation is calculated on the ground, before the turbojet engine starts up. Preferably again, the rotors of the turbojet engine are not in rotation. Similarly, when measuring the deviations between the measurements of the measuring chain, here pressure P23 at the output of the high-pressure compressor and the ambient pressure Pamb of the turbojet engine supplied by the aircraft, an increase in the number of deterioration indicators and an improvement in the detection of a failure of a measuring chain component are obtained. For pressures P23 and Pamb are in principle equal before the turbojet engine starts up. Any deviation is thus a sign of deterioration.

Preferentially, the method includes a step for comparing the evolution of the slope of the abnormality score with a threshold of maximal abnormality before failure. The distribution of the probability of violation of the threshold of maximal abnormality before failure through the evolution of the slope of the abnormality score is characteristic of the failure probability of a measuring chain at a given term. It is thus possible to anticipate a maintenance step whereas no failure effectively arose yet.

Still preferably, the value of the threshold of maximal abnormality before failure is defined by learning during several no-deterioration flight cycles of an aircraft. Preferentially, the value of the threshold of maximal abnormality before failure is obtained by simulating the impact of a deterioration on all the indicators. So, robustness and quality of the deterioration detection are ensured.

The invention will be better understood when reading the following description given by way of example only and referring to the accompanying drawings wherein:

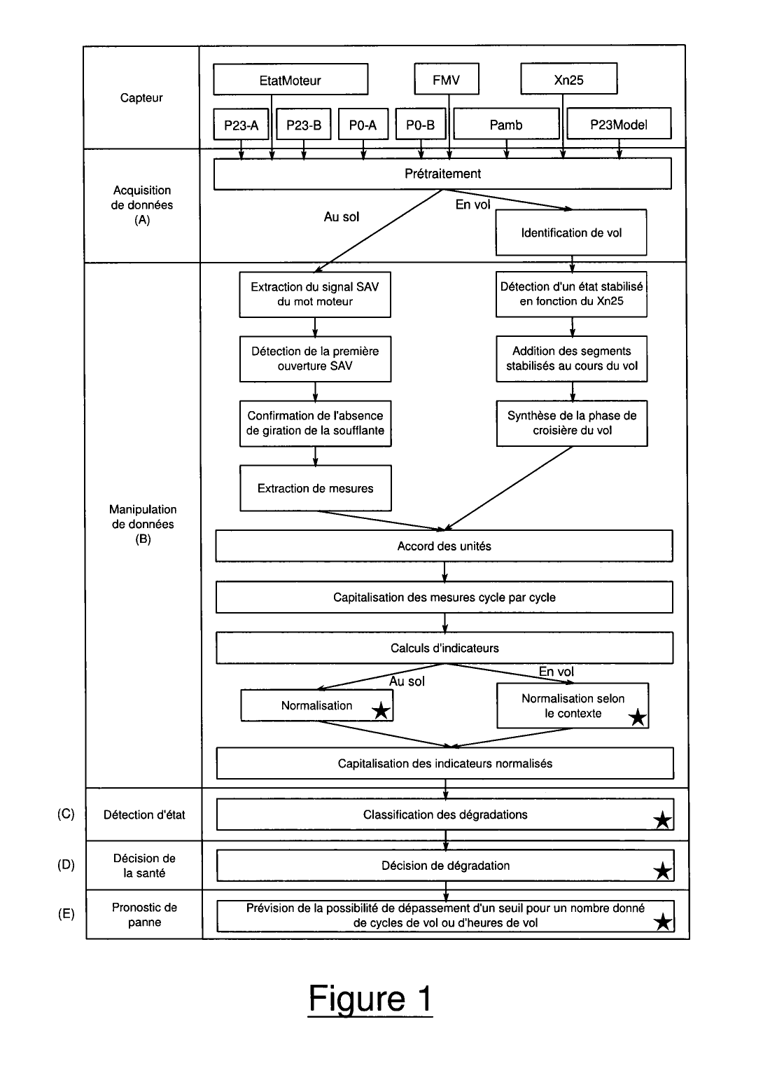

FIG. 1 is a schematic diagram of the method for monitoring a measuring chain of a turbojet engine according to the invention;

FIG. 2 is a schematic representation of the geodesic comparison of a current deterioration vector with reference vectors with deterioration which are characteristic of predetermined deteriorations; and

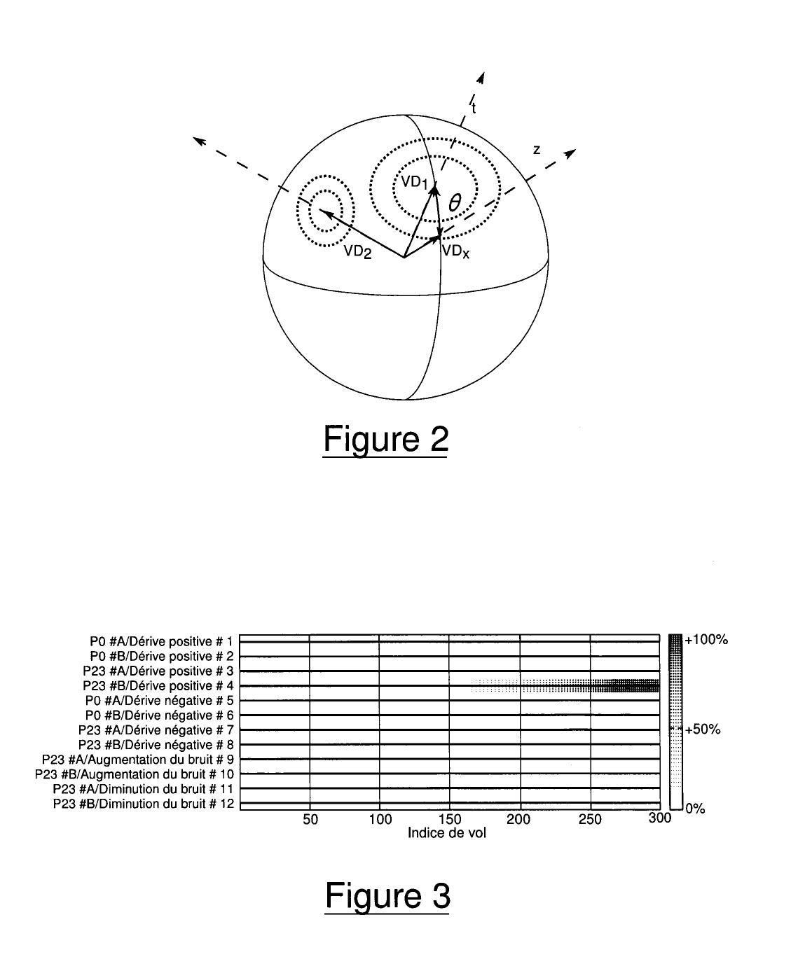

FIG. 3 is a representation of a decision display for analysing the deteriorations of a measuring chain of a turbojet engine.

Then the method for monitoring is going to be explained in connection with a twin-shaft turbojet engine comprising a low-pressure LP body and a high-pressure HP body. Such a turbojet engine is known to the person skilled in the art. The method for monitoring a measuring chain is going to be explained in reference to FIG. 1 showing:
a step (A) of acquisition of measurements;
a step (B) of processing of measurements;
a step (C) of classification of deteriorations;
a step (D) of deterioration decision; and
a step (E) of failure forecast.

A. Acquisition of Measurements

A first step of the monitoring method consists in acquiring measurements of variables of the turbojet engine. As an example, in reference to FIG. 1, the turbojet engine is equipped with sensors for measuring the following variables:
ambient pressure PO of the turbojet engine;
pressure P23 at the output of the HP compressor;
ambient pressure Pamb supplied by the aircraft on which the turbojet engine is mounted;
rotation speed Xn25 of the HP body;
position of the fuel metering valve FMV; and
a “state of the engine” variable making it possible to supply the opening time of the starter shut-off valve (see below) as well as the flight-cycle phase of the turbojet engine (see below).

In this example, ambient pressure P0 of the turbojet engine and pressure P23 at the output of the HP compressor are both measured by a measuring chain comprising two replicated measuring channels (A and B). So, ambient pressure P0 of the turbojet engine is measured according to two measuring channels referenced P0-A and P0-B whereas pressure P23 at the output of the HP compressor is measured according to two measuring channels referenced P23-A and P23-B.

In order to have reliable measurements for failure prediction, the raw measurements acquired by the sensors undergo a pre-processing which usually consists in deleting the aberrant measurements by comparing them with the precision of the sensor or the physical limit of the sensor which achieved the measurement.

Preferably, the measurements are achieved in steady operating ranges of the turbojet engine in order to increase the reliability of the measurements. In this example, measurements are achieved, on the one hand, when the turbojet engine is out (aircraft on the ground) and, on the other hand, when the aircraft is in flight.

Ground Measurements

As far as the ground measurements are concerned, the turbojet engine being switched off, acquisition starts at the opening of the starter shut-off valve, known to the person skilled in the art under its English abbreviation SAV for “Starter Air Valve”. In this example, the opening of the starter shut-off valve is supplied by the “engine state” variable. The opening of the starter shut-off valve occurs before the start of the turbojet engine and makes it possible to make sure that the turbojet engine is out. Preferably, the number of openings of the starter shut-off valve is detected and acquisition of the measurements starts only at the first opening of the starter shut-off valve. Preferentially, the absence of gyration of the turbojet engine fan, known to the person skilled in the art under the designation “Windmilling”, is verified before acquisition of the measurements begins.

In-Flight Measurements

As far as the in-flight measurements are concerned, the acquisition starts when the rotation speed Xn25 of the HP body is steady. To improve the reliability of the in-flight measurements, the acquisition is achieved over a plurality of time segments of stabilized operation, preferably when the turbojet engine is in steady-state phase. Then, the measurements acquired over all the stabilized time segments are consolidated in order to be representative of a phase of stabilized operation of the turbojet engine when the aircraft is in flight.

B. Processing of the Measurements

As explained previously, the step for processing the measurements aims at forming deterioration indicators which are representative of the deviations between the measurements of the variables of the turbojet engine as set out in application FR 2 939 924.

After obtaining measurements on the ground and in flight comes a step for homogenizing the units of the measurements so as to be able to achieve mathematical operations on the said measurements, whether they were obtained on the ground or in flight. Preferably, the acquired measurements, in flight or on the ground, are consolidated over several operating cycles of the turbojet engine, for instance over a few flights.

Definition of the Deterioration Indicators

To monitor the health of a measuring chain, to begin with, deterioration indicators which are sensitive to deteriorations of the following types are defined:
positive or negative skew or drift,
increase or decrease of noise.

In this example, several deterioration indicators which are a function of the measurement of ambient pressure P0 according to the first measuring channel P0-A, the measurement of ambient pressure P0 according to the second measuring channel P0-B, the measurement of pressure P23 at the output of the HP compressor according to the first measuring channel P23-A and the measurement of pressure P23 at the output of the HP compressor according to the second measuring channel P23-B are defined.

Pressure Pamb supplied by the aircraft on which the turbojet engine is mounted is also used to form deterioration indicators given that it corresponds to the same variable as P0-A and P0-B when the aircraft is stationary on the ground and in the absence of gyration of the fan. Likewise, variables P23-A and P23-B also correspond to pressure Pamb supplied by the aircraft when the aircraft is stationary on the ground, in the absence of gyration of the fan.

On the ground, the following 10 deterioration indicators are defined:

O ID1 (deviation between P0-A and P0-B)

O ID2 (deviation between P0-A and Pamb)

O ID3 (deviation between P0-B and Pamb)

O ID4 (deviation between P0-A and P23-A)

O ID5 (deviation between P0-A and P23-B)

O ID6 (deviation between P0-B and P23-A)

O ID7 (deviation between P0-B and P23-B)

O ID8 (deviation between P23-A and P23-B)

O ID9 (deviation between P23-A and Pamb)

O ID10 (deviation between P23-B and Pamb)

In flight, the theoretical model P23_{Model} of the turbojet engine which estimates pressure P23 at the output of the HP compressor for given operating conditions of the turbojet engine is also used over a stabilized operating range to form deterioration indicators. In other words, the theoretical model P23_{Model} makes it possible to supply at the output an estimated pressure P23s at the output of the HP compressor for given input values. The theoretical model P23_{Model} is a theoretical thermodynamic model of the turbojet engine. The input data of the theoretical model P23_{Model} are characteristic of the operating mode of the turbojet engine. This theoretical model is identical for all turbojet engines of the same type and does not take account of the specificities which are characteristic of each turbojet engine. As a result such a theoretical model may supply an inaccurate estimate of pressure P23s at the HP compressor output.

The estimated pressure P23s is advantageously compared with pressures P23-A, P23-B to form in-flight deterioration indicators. The following six deterioration indicators are defined in flight:

O ID11 (mean deviation between P23-A and P23-B),

O ID12 (mean deviation between P23-A and P23s),

O ID13 (mean deviation between P23-B and P23s),

O ID14 (RMS deviation between P23-A and P23-B),

O ID15 (RMS deviation between P23-A and P23s),

O ID16 (RMS deviation between P23-B and P23s).

Ten mean deviations (positive or negative skew or drift) between the five measurements of variables Pamb, P0-A, P0-B, P23-A and P23-B are calculated two by two in order to determine the ground deterioration indicators ID1 to ID10.

The three mean deviations (positive or negative skew or drift) and the three RMS deviations (increase or decrease of the noise) between the three measurements of variables P23-A, P23B and P23s are calculated two by two in order to determine the in-flight deterioration indicators loll to ID16.

As mentioned previously, deterioration indicators are sensitive to given types of deterioration. In this example, twelve different deteriorations shown in the table below are analyzed. Each deterioration is associated with a reference number which is used in FIG. 3 showing a decision display which will be discussed later.

| | P0-A | P0-B | P23-A | P23-B |
|---|---|---|---|---|
| Positive skew or drift | #1 | #2 | #3 | #4 |
| Negative skew or drift | #5 | #6 | #7 | #8 |
| Increase of noise | | | #9 | #10 |
| Decrease of noise | | | #11 | #12 |

A decrease of the noise does not correspond as such to a deterioration of the turbojet engine but, on the contrary, to an improvement. A decrease of the noise is particularly useful to monitor the effects of a maintenance step performed on the turbojet engine.

In practice, since the estimated pressure P23s at the output of the HP compressor is inferred using the theoretical model P23_{Model} which is defined for an average turbojet engine, the result of this is an inaccuracy of estimated pressure P23s and thus an inaccuracy of the in-flight deterioration indicators which depend upon this estimate. So that this drawback is eliminated, the deterioration indicators formed from estimated pressure P23s are normalized by taking account of the operating mode of the turbojet engine in order to improve their accuracy. In practice, only the indicators calculating the mean deviations and RMS deviations between P23s and P23-A or P23-B are normalized by taking account of the operating mode of the turbojet engine (deterioration indicators ID2, ID3, ID15 and ID16).

Normalization of an Indicator

In a known manner, normalization models of deterioration indicators are formed as set out in application FR 2 939 924 A1. In practice, a process of regression is used by analyzing the differences between the observed indicators and the indicators estimated by regression so as to normalize the deterioration indicators.

Generally, the regression model makes it possible to estimate a raw indicator according to the other indicators (see the case of indicators ID2, ID3, ID15, ID16 afterwards). The normalized indicator is equal to the difference between the raw indicator and the regression estimate of the raw indicator. Preferably, the deterioration indicators are centred and reduced during normalization.

The average for centring is estimated using the average of the deviations, during the learning flights, between an indicator and an indicator estimated by regression. The standard deviation for the reduction is estimated using the standard deviation of the deviations, during the learning flights, between an indicator and an indicator estimated by regression.

The mean deviations and RMS deviations between PS3-A and P23s, P23B and P23s are estimated using a regression relationship including a variable which is characteristic of the turbojet engine operation in order to increase the accuracy of the normalized in-flight deterioration indicators. In other words, the deterioration indicators are normalized according to an operating variable characteristic of the turbojet engine in order to correct the inaccuracy of the in-flight deterioration indicators relative to the correlation of the deviations with the operating variables of the turbojet engine (RPM of the LP body, RPM of the HP body, temperature at the output of the HP compressor, etc.).

According to the invention, a normalization of the deviations with regard to a single operating variable is enough to improve the reliability of the in-flight deterioration indicators given that the operating variables of a turbojet engine are correlated between them. Preferentially, the deviations are set according to the position of the fuel metering valve, known under its English abbreviation FMV for “Fuel oil Metering Valve”. The position of the fuel metering valve FMV is characteristic of the operating mode of the turbojet engine and is simply and precisely measurable.

Thanks to the position of the fuel metering valve FMV, it is possible to obtain relevant normalization models by learning and normalize the deterioration indicators formed from the estimated pressure P23s and so improve the accuracy of the deterioration indicators. With only a single additional measurement, in this example the position of the fuel metering valve FMV, the inaccuracy of the deterioration indicators which is linked to the correlation of the deviations “measurement—mean theoretical model” with the operating mode of the turbojet engine is corrected. Thanks to a normalized deterioration indicator, it is advantageously possible to characterize the deterioration by way of a geodesic comparison, as it will be explained later.

As an example, considering a deterioration indicator ID15 equal to the mean deviation between P23-A and P23s, the normalized deterioration indicator ID15norm is defined as follows:

$$ID 15 norm = \frac{( \begin{matrix}( ID 15 courant - \\ ID 15 prédit ( FMV , ID 1 , ID 2 , … , ID 14 , ID 16 ) - μ\end{matrix} )}{σ} \qquad ( 1 )$$

In the previous formula,
ID15courant corresponds to the current deterioration indicator ID15 obtained during the monitoring phase;
ID15prédit corresponds to deterioration indicator ID15 predicted by regression during the said flight according to the position of the fuel metering valve FMV and the value of the other deterioration indicators (15 other deterioration indicators in this case);
μ is the average of the differences between current deterioration indicator ID15courant and an estimated deterioration indicator ID15estimé obtained by regression during no-deterioration learning flights; and
σ is the standard deviation of the differences between the current deterioration indicator ID15courant and an estimated deterioration indicator ID15estimé obtained by regression during no-deterioration learning flights.

The regression relationship is as follows:

ID15prédit=f(FMV, ID1, ID2, . . . , ID14, ID16)

This regression relationship is generally learnt during the same learning flights as μ and σ.

As regards the position of the fuel metering valve FMV, the average of the position of the fuel metering valve FMV during a steady phase of the turbojet engine is taken into account.

C. Classification of the Deterioration Indicators

For each flight a deterioration vector which has in this example 16 dimensions corresponding to the 16 previously set out deterioration indicators ID1norm to ID16norm is formed in order to classify a deterioration,.

The deterioration vector is compared with a base of reference vectors defined for deteriorations of each type #1 to #12 in order to classify the deterioration vector.

Each reference vector is typical of a given type of deterioration. Like a deterioration vector, a reference vector has 16 dimensions, one for each deterioration indicator. In other words, each reference vector is made up of 16 reference indicators which are characteristic of a type of deterioration.

Healthy turbojet engines have deterioration indicators that are healthy (without any skew, drift or noise) unlike turbojet engines presenting a deterioration the deterioration indicators of which are characteristic of the deterioration of the said turbojet engine. Impact models which modify healthy indicators obtained for a healthy turbojet engine according to the intensity of the impact, i.e. according to the intensity of skew or noise deterioration, are used to form reference indicators with deterioration. So, reference indicators with deterioration are obtained by modifying healthy indicators.

The table below shows the relationship between deterioration indicators ID1 to ID16 and deteriorations #1 to #12 used for the modification of healthy indicators. In other words, the table indicates the deteriorations which are simulated for each deterioration indicator. In this table, the signs “+” correspond to increases of the deterioration indicators whereas the signs “−” correspond to decreases.

| | ID1 | ID2 | ID3 | ID4 | ID5 | ID6 | ID7 | ID8 | ID9 | ID10 | ID11 | ID12 | ID13 | ID14 | ID15 | ID16 |
|---|---|---|---|---|---|---|---|---|---|---|---|---|---|---|---|---|
| #1 | + | + | | + | + | | | | | | | | | | | |
| #2 | | | + | | | + | + | | | | | | | | | |
| #3 | | | | − | | − | | + | + | | + | + | + | | | |
| #4 | | | | | − | | − | − | | + | − | | + | | | |
| #5 | − | − | | − | − | | | | | | | | | | | |
| #6 | + | | − | | | − | − | | | | | | | | | |
| #7 | | | | + | | + | | − | − | | − | − | | | | |
| #8 | | | | | + | | + | + | | − | + | | − | | | |
| #9 | | | | | | | | | | | | | | + | + | |
| #10 | | | | | | | | | | | | | | − | | + |
| #11 | | | | | | | | | | | | | | − | − | |
| #12 | | | | | | | | | | | | | | + | | − |

The forming of the base of reference vectors is obtained by learning, by implementing previous steps A to C, in order to enable classification of the deterioration vectors obtained in the course of a flight, during a monitoring phase, as it is known from patent application FR 2 939 924.

Each deterioration vector obtained during the monitoring is compared with the reference vectors so as to determine the most likely deterioration. Each deterioration vector is thus associated with a given type of deterioration. In a known manner, a comparison based on the geodesic distances

between the deterioration vectors and the reference vectors of the reference base is achieved. A given deterioration vector VDx and two reference vectors VD1, VD2 are shown as an example in FIG. 2.

D. Deterioration Decision

The abnormality score for each deterioration vector is calculated, for instance by means of Mahalanobis standard as explained in patent application FR 2 939 924, in order to detect a deterioration of a measuring chain in a definite turbojet engine.

Each abnormality score of a given deterioration vector is then compared with a decision threshold of abnormality which is characteristic of the type of deterioration determined during the classification step. In other words, the decision threshold depends on the class of the deterioration vector.

In case of violation of the said decision threshold of abnormality, it is considered that the observed deterioration is a known fact. Preferentially, a decision threshold of abnormality is obtained by learning during a plurality of flights for each type of deterioration (drift, skew, noise, etc.).

E. Failure Forecast

This step advantageously makes it possible to forecast from which time on a deterioration of the measuring chain will result in an actual failure of the said measuring chain.

To do this, the deterioration indicators of maximal intensity for which the deterioration is maximal are learned. In other words, a base of deterioration indicators which represents the state of the measuring chain just before the failure breaks out is formed.

Like in the previous step, a global abnormality score for all the deterioration indicators is calculated, for example by means of Mahalanobis standard as set out in patent application FR 2 939 924. Next, the global abnormality score for the base of deterioration indicators of maximal intensity is designated threshold of maximal abnormality before failure.

Then the global abnormality score for the deterioration indicators obtained during the monitoring is calculated and its evolution is analyzed in order to determine from which term on it is going to exceed the threshold of maximal abnormality before failure, i.e. at which time a deterioration is going to turn into a failure.

According to the invention, the decision whether a maximal abnormality before failure exists or not is based on the evolution of the abnormality score, the evolution of its average or the evolution of its variation (measurement of the slope of the abnormality score).

According to an aspect of the invention, it is desirable that the probability of failure at a given term is obtained. To do this, the distribution of the probability of violation of the threshold of maximal abnormality before failure is analyzed over the time, for instance during a certain number of flights.

In this example, the distribution of the probability of violation of the threshold of maximal abnormality before failure is analyzed through the evolution of the slope of the global abnormality score for a given deterioration. The slope can be considered according to the flights or according to the hours flown, depending on the variable the deterioration phenomenon is linked to.

As an example, referring to the decision display of FIG. 3, a visual representation of the deterioration probability (colour of the table) for each type of deterioration (one deterioration per line of the table) according to the number of flights (the number of flights being indicated by the columns of the table) is obtained.

So, in this example, a positive drift of the measurement of pressure P23 at the output of the HP compressor is detected in measuring channel B (deterioration #4). Its probability of appearance increases importantly from flight No. 220 on and is almost sure from flight No. 270 on. So it is possible to predict the deterioration of measurement P23-B thanks to the previously set out method even before measurement P23-B becomes incorrect and requires a maintenance operation.

Advantageously, if a maintenance operation for the turbojet engine is already scheduled for flight No. 250, it is possible to replace the measuring channel P23-B during this maintenance operation. By grouping together the maintenance operations, the availability of the aircraft is increased, which is very advantageous.

Several learning phases for obtaining, for instance, models for normalizing the deterioration indicators, healthy indicators in order to form a base of reference vectors, decision thresholds of abnormality and thresholds of maximal abnormality before failure were previously set out. Preferably, the learning phases are characteristic of each turbojet engine and are renewed after each maintenance step so as to precisely follow the evolution of the state of the turbojet engine and its measuring chains. The steps of the method including a learning phase are marked with a star in FIG. 1.

During the learning phase, the measurements are achieved for a plurality of no-deterioration flights spreading over a period of one or several months in order to enable learning of the regression models, for example for the normalization of the deterioration indicators. During the monitoring phase, the measurements are achieved for a plurality of flights spreading over a period of the order of one day so as to have consolidated measurements at one's disposal.

1. Method for monitoring a measuring chain of an aircraft turbojet engine, the measuring chain comprising at least two replicated channels for measuring a variable of the turbojet engine, the method including:
a step for measuring a variable of the turbojet engine by each of the two measuring channels during a flight of the aircraft;
a step for estimating the said variable by means of a mean theoretical internal model of the turbojet engine;
a step for calculating a deviation between the measurement of one of the measuring channels and the estimate of the said variable in order to form an indicator of deterioration of the measuring chain;
a step for comparing the deterioration indicator with a reference base of indicators with deterioration so as to infer from it the type of deterioration;
a step for calculating an abnormality score for the deterioration indicator;
a step for comparing the abnormality score with a decision threshold of abnormality characteristic of the type of deterioration;
a step for releasing an alarm in case of violation of the decision threshold of abnormality;
method including a step for measuring the position of a fuel metering valve of the turbojet engine during the flight of the aircraft and a step for normalizing the deterioration indicator according to the position of the fuel metering valve.

2. Method according to claim 1, in which the deterioration indicator is normalized using a normalization model obtained by learning from data of flight without deterioration, the normalization model depending on the position of the fuel metering valve.

3. Method according to claim 2, in which the normalization model is obtained by regression of the deterioration indicator representing the deviation between the measuring channel and the mean theoretical model according to the position of the fuel metering valve.

4. Method according to claim 1, in which, the turbojet engine comprising a low-pressure body and a high-pressure body, the measured variable of the turbojet engine is pressure P23 at the output of the high-pressure compressor.

5. Method according to claim 1, including a step for calculating a mean deviation or a root mean square deviation between the measurement of one of the measuring channels and the estimate of the said variable by the mean theoretical internal model in order to form an indicator of deterioration of the measuring chain.

6. Method according to claim 1, including a step for calculating a mean deviation or a root mean square deviation between at least one of the two measuring channels of the said chain for measuring the said given variable and at least one of the two measuring channels of a chain for measuring the ambient pressure P0 of the turbojet engine.

7. Method according to claim 1, including a step for calculating a mean deviation or a root mean square deviation between at least one of the two measuring channels of the said measuring chain for the said given variable and the measurement of the ambient pressure Pamb of the turbojet engine supplied by the aircraft on which the turbojet engine is mounted.

8. Method according to claim 1, including a step for comparing the evolution of the slope of the abnormality score with a threshold of maximal abnormality before failure.

9. Method according to claim 8, in which the value of the threshold of maximal abnormality before failure is defined by learning in the course of several no-deterioration flight cycles of an aircraft.
